(19) United States
(12) Patent Application Publication
(10) Pub. No.: US 2004/0108627 A1
(43) Pub. Date: Jun. 10, 2004

(54) Blown pet handleware for containers

(76) Inventor: Ronald C. Schumann, Aurora, IL (US)

Correspondence Address: KNOBLE & YOSHIDA, LLC, Suite 1350, Eight Penn Center, 1628 John F. Kennedy Blvd., Philadelphia, PA, 19103, US

(21) Appl. No.: 10/313,221

(22) Filed: Dec. 6, 2002

(51) Int. Cl. B29C 49/06; B29C 49/64

(52) U.S. Cl. 264/535; 264/537; 425/533; 425/522

(57) ABSTRACT

A system and method for making a specialized preform and for fabricating a container from the specialized preform includes a first preform molding assembly in which a preliminary preform is molded so as to have a first sidewall portion that is thicker than the surrounding sidewall areas. A final preform is molded from the primary preform in a second preform molding assembly, wherein fluid pressure is utilized to mold the thickened first sidewall portion into a lateral projection that corresponds and size in shape to a handle structure that is desired in the final container. The specialized final preform is then positioned within a container mold that is constructed to pinch the lateral projection during blowmolding of the final container so as to define an integral molded handle portion having a central sealed slug area that is later removed.

### BACKGROUND OF THE INVENTION

1. Field of the Invention

This invention relates to an improved handle assembly for plastic containers, such as the strain-oriented blow-molded PET containers that are in common use for packaging consumer materials and beverages such as soft drinks.

2. Description of the Related Technology

Blow-molded strain-oriented polyethylene terephthalate (PET) containers are in wide use throughout the world because of their chemical suitability for safely packaging consumer products such as foods and beverages, wide adaptability to different shapes and sizes, and their sufficient toughness to maintain structural integrity at different temperatures, even when stressed with internal pressurization.

There is a growing demand in the packaging field for such containers to be provided with handles, particularly in the case of larger containers, such as gallon containers, which can be quite heavy when filled with a liquid such as a soft drink. Certain handle designs that are limited in shape and size can be formed into PET containers during the molding process, however the nature of the molding process does not permit longer, thinner handles to be efficiently formed so as to have the requisite thickness and biaxial stretch. These problems are discussed at some length in U.S. Pat. No. 4,629,598 to Thompson.

As a result of these limitations, efforts have been made to design container assemblies that include separate handles that are attached after the molding process is completed. Such efforts are detailed in U.S. Pat. No. 5,637,167 to Krishnakumar et al. and other U.S. patents, such as U.S. Pat. Nos. 5,074,506; 5,918,754; 5,931,324 and 5,469,612.

While several of the solutions described in the U.S. patents listed above are workable to some extent in practice, disadvantages exist. For example, many of the handles described in the patent literature and that have been employed commercially tend to be fairly rigid and yet must be deformed to some extent (or cause the container itself to be deformed) when being mounted on the container. This need for deformation during mounting can cause structural weaknesses that can create problems later, especially if the contents of the container are pressurized or if the container is quite large and heavy. Moreover, secondary handles tend to be problematic because they tend to be fabricated from different plastic materials than a material from which the container itself is fabricated. This creates problems during the past consumer recycling process, wherein different types of plastics must be separated prior to recycling.

A need exists for a system and method for integrally molding an effective handle structure to a plastic container that is formed using the PET blowmolding fabrication process.

### SUMMARY OF THE INVENTION

Accordingly, it is an object of the invention to provide an improved system and method for integrally molding an effective handle structure to a plastic container that is formed using the PET blowmolding fabrication process.

In order to achieve the above and other objects of the invention, a mold assembly for fabricating a PET preform for use in making a plastic container includes, according to a first aspect of the invention, a mold body having a cavity defined therein, said cavity being shaped in accordance with a desired shape of an outer surface of a preform to be molded; a mold core for shaping an inner surface of the preform, the mold core having at least one opening defined in an outer surface thereof, the mold core further having an internal passage defined therein that is in communication with said opening; and a source of pressurized fluid in communication with the internal passage, whereby pressurized fluid may be applied to the inner surface of the preform in order to mold the preform to the desired final shape of the preform.

According to a second aspect of the invention, a system for fabricating a PET preform for use in making a plastic container, includes a first mold assembly for performing a primary preform molding operation; a second mold assembly for performing a secondary preform molding operation, and wherein the second mold assembly includes structure for applying a fluid pressure differential to the preform in order to change the shape of the preform during molding.

According to third aspect of the invention, a method of fabricating a PET preform for use in making a plastic container includes steps of molding a primary preform shape in a first stage molding operation; and molding a final preform in a second stage molding operation, and wherein the step of molding a final preform shape in a second stage molding operation is performed by applying a fluid pressure differential to at least a portion of the primary preform shape in order to attain the final preform.

According to a fourth aspect of the invention, a method of making a plastic container having an integral handle includes steps of providing a preform that has a lateral projection that substantially corresponds to the desired shape and size of a handle; positioning the preform within a container mold assembly; and forming a completed container with an integral handle by molding the preform to the desired final shape that is defined by the container mold assembly.

According to a fifth aspect of the invention, a mold assembly for making a plastic container having an integral handle includes an internal surface that a shape and size so as to correspond to a desired final shape of a container; and sealing structure for pinching a lateral projection that is defined on a preform together so as to define a sealed portion in which plastic material is sealed together.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a cross-sectional view depicting a first step of making a preform according to a preferred embodiment of the invention;

FIG. 2 is a diagrammatical cross-sectional depiction of a second step of making a preform according to the preferred embodiment of the invention;

FIG. 3 is a lateral cross-sectional view of a completed preform that is constructed according to the preferred embodiment of the invention;

FIG. 4 is a diagrammatical cross-sectional view depicting placement of a preform constructed according to the preferred embodiment of the invention into a container mold assembly that is constructed according to a preferred embodiment of the invention;

FIG. 5 is a diagrammatical cross-sectional view depicting a completed container after blowmolding in the container mold assembly;

FIG. 6 is a fragmentary cross-sectional view depicting a portion of the completed container shown in FIG. 5; and

FIG. 7 is a schematic diagram depicting a process that is performed according to a preferred embodiment of the invention.

### DETAILED DESCRIPTION OF THE PREFERRED EMBODIMENT(S)

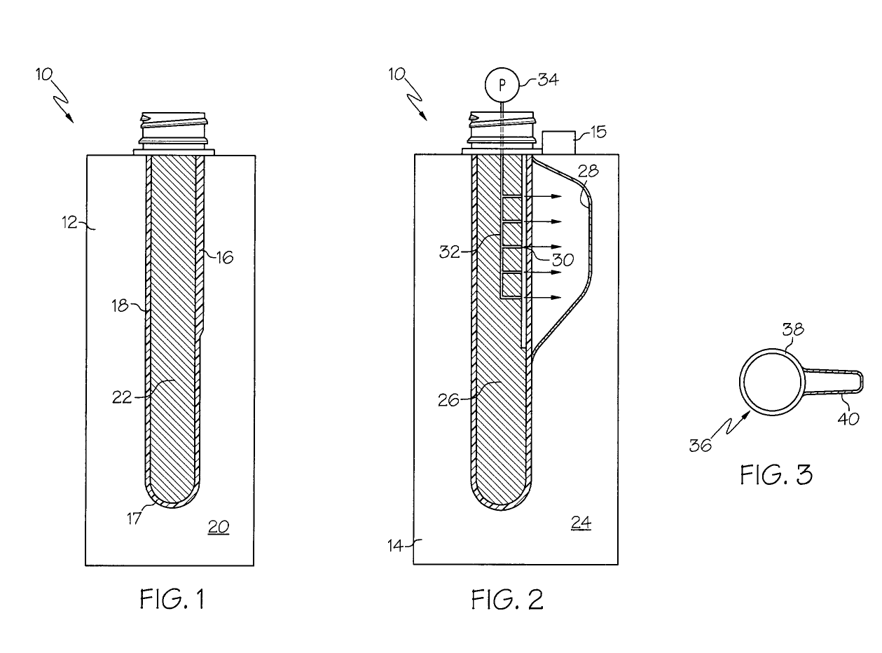

Referring now to the drawings, wherein like reference numerals designate corresponding structure throughout the views, and referring in particular to FIG. 1, a system 10 for fabricating a PET preform 36 for use in making a plastic container 48 includes a first mold assembly 12 for performing a primary preform molding operation and a second mold assembly 14 for performing a secondary preform molding operation. As may be seen in FIG. 1, first mold assembly 12, which includes a mold body 20 defining a cavity and a mold core 22, is shaped so as to mold a preliminary, initial stage preform member 17 that has a first sidewall portion 16 that is formed so as to be substantially thicker than surrounding portions 18 of the sidewall. Referring now to FIG. 2, it will be seen that second mold assembly 14 includes structure 15 for orienting the preliminary, initial stage preform member 17 so that it assumes a desired orientation with respect to the second mold assembly 14. Second mold assembly 14 further includes a mold body 24 defining a cavity and a novel, advantageous mold core 26 that includes structure for applying a fluid pressure differential to the preliminary, initial stage preform member 17 in order to change the shape of the preform 17 during molding. As may be seen in FIG. 2, the cavity defined by mold 24 includes a lateral projection 28, to which the first sidewall portion 16 of the preliminary preform member 17 is oriented to face during the secondary molding process. Preferably, lateral projection 28 is shaped and sized so as to define a lateral projection on the completed preform 36 that is substantially similar in shape and size to a desired integral handle projection on the completed container 48, as will be described in greater detail below.

As may further be seen in FIG. 2, a surface of the mold core 26 that is aligned with the lateral molding recess 28 as a plurality of openings 30 defined therein, each of which is in communication with an internal passage 32 that is defined within the mold core 26. Internal passage 32 in turn is communicated with a pressure source 34, with appropriate valving and control structure, so that a fluid pressure differential may be applied to the thickened first sidewall portion 16 of the preliminary preform 17 during the secondary molding process in order to cause the thickened first sidewall portion 16 to accommodate itself to the lateral recess 28 during the secondary molding process. As may be seen in FIG. 3, which is a lateral cross-section of a completed preform 36, the completed preform includes a main generally cylindrically shaped body 38 and a lateral handle projection 40 that is generally shaped according to the shape of the lateral recess 28 in the mold body 24 of the second mold assembly 14.

Preferably, the primary preform shape 17 is maintained at a predetermined minimum temperature in the period of time after its fabrication in the first mold assembly 12 to its reformation into the completed preform 36 in the second molding assembly 14. In the preferred embodiment of the invention, this predetermined minimum temperature is at least about 160 degrees Centigrade.

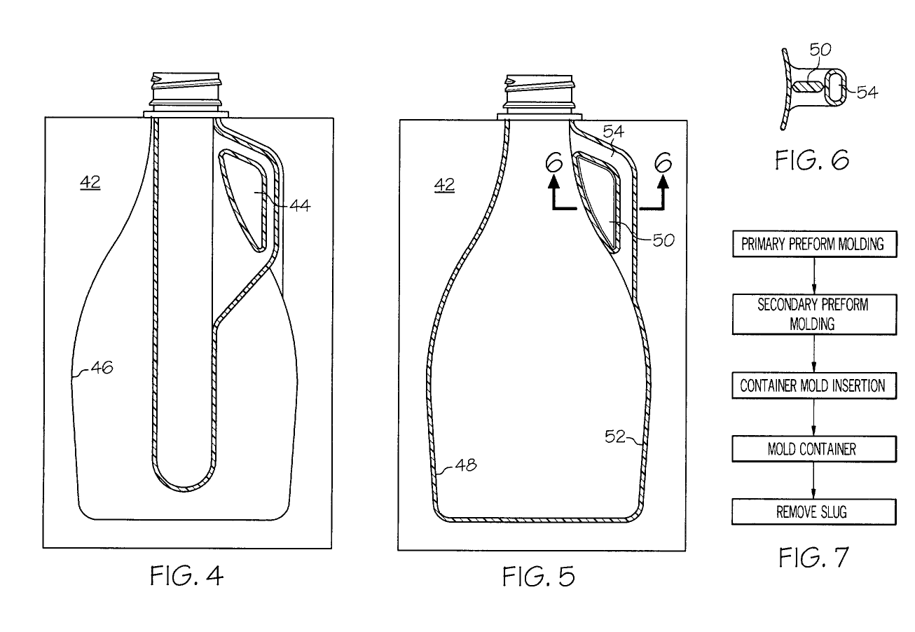

Referring now to FIG. 4, the completed preform 36 will be positioned within a container mold assembly 42 having an internal mold surface 46 that is shaped and size to approximate the desired final shape and size of the completed container 48. As may be seen in FIG. 4, pinching structure 44 is provided as part of the container molding assembly 42 in order to pinch an area of the lateral handle projection 40 together so as to define a sealed portion in which plastic material is sealed together. Preferably, as may be seen in the detailed cross-section of the handle area 54 of the completed container 48 that is provided in FIG. 6, pinching structure 44 is constructed so as to press together the PET material in a broad, central area, and so as to further mold a thin frangible web connecting the broad central area to the surrounding handle structure and the main body of the completed container 48. Referring to FIG. 5, which depicts the completed container 48 within the container mold assembly 42 after the blowmolding process is performed, this broad central area that is created by the pinching structure 44 forms a slug 50 that is easily removed from the completed container structure 48 in a subsequent manufacturing step.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A mold assembly for fabricating a PET preform for use in making a plastic container, comprising:
a mold body having a cavity defined therein, said cavity being shaped in accordance with a desired shape of an outer surface of a preform to be molded;
a mold core for shaping an inner surface of the preform, said mold core having at least one opening defined in an outer surface thereof, said mold core further having an internal passage defined therein that is in communication with said opening; and
a source of pressurized fluid in communication with said internal passage, whereby pressurized fluid may be applied to the inner surface of the preform in order to mold the preform to the desired final shape of the preform.

2. A system for fabricating a PET preform for use in making a plastic container, comprising:
a first mold assembly for performing a primary preform molding operation;
a second mold assembly for performing a secondary preform molding operation, and wherein said second mold assembly includes structure for applying a fluid pressure differential to the preform in order to change the shape of the preform during molding.

3. A system according to claim 2, wherein said first mold assembly is configured so as to mold a first sidewall portion of the preform to a greater thickness than a second sidewall portion of the preform.

4. A system according to claim 3, wherein said second mold assembly include structure for orienting the preform so that the first sidewall portion assumes a desired orientation with respect to the second mold assembly.

5. A system according to claim 4, wherein said second mold assembly is shaped so as to cause a lateral projection to be formed in the preform during the secondary preform molding operation, and wherein said structure for orienting the preform is configured so as to orient the first sidewall portion of the preform to face the mold structure that will form the lateral projection.

6. A system according to claim 5, wherein said structure for applying a fluid pressure differential to the preform is configured to apply the fluid pressure differential to the first sidewall portion of the preform in order to urge the first sidewall portion of the preform into the mold structure that will form the lateral projection.

7. A system according to claim 2, wherein said second mold assembly is shaped so as to cause a lateral projection to be formed in the preform during the secondary preform molding operation.

8. A system according to claim 7, wherein said second mold assembly shaped so as to cause a handle defining projection to be formed in the preform during the secondary preform molding operation.

9. A system according to claim 2, wherein said second mold assembly comprises a mold core for shaping an inner surface of the preform, and wherein said structure for applying a fluid differential comprises at least one opening defined in an outer surface of said mold core, said structure for applying a fluid differential further comprising an internal passage defined in said mold core that is in communication with said opening and a source of pressurization that is in communication with the internal passage.

10. A method of fabricating a PET preform for use in making a plastic container, comprising:
(a) molding a primary preform shape in a first stage molding operation; and
(b) molding a final preform in a second stage molding operation, and wherein said step of molding a final preform shape in a second stage molding operation is performed by applying a fluid pressure differential to at least a portion of the primary preform shape in order to attain the final preform.

11. A method of fabricating a PET preform according to claim 10, further comprising a step of maintaining the primary preform shape at at least a predetermined minimum temperature prior to said step of molding a final preform in a second stage molding operation.

12. A method of fabricating a PET preform according to claim 11, wherein said predetermined minimum temperature is at least 160 degrees Centigrade.

13. A method of fabricating a PET preform for use in making a plastic container according to claim 10, wherein said step of molding a primary preform shape is performed in a first mold assembly, and wherein said step of molding a final preform is performed in a second mold assembly.

14. A method of fabricating a PET preform according to claim 13, wherein said step of molding a primary preform shape is performed so as to mold a first sidewall portion of the primary preform shape to a greater thickness than a second sidewall portion of the primary preform shape.

15. A method of fabricating a PET preform according to claim 14, further comprising a step of orienting the primary preform shape prior to said step of molding a final preform so that the first sidewall portion assumes a desired orientation.

16. A method of fabricating a PET preform according to claim 15, wherein said step of molding a final preform is performed so as to cause a lateral projection to be formed in the final preform, and wherein said step of orienting the preform is performed so that the first sidewall portion is oriented so as to face the mold structure that will form the lateral projection.

17. A method of fabricating a PET preform according to claim 16, wherein said step of applying a fluid pressure differential to the preform is is performed so as to apply the fluid pressure differential to the first sidewall portion of the preform in order to urge the first sidewall portion of the preform into the mold structure that will form the lateral projection.

18. A method of fabricating a PET preform according to claim 10, wherein said step of molding the final preform is performed so as to cause a lateral projection to be formed in the final preform.

19. A method of fabricating a PET preform according to claim 18, wherein said said step of molding the final preform is performed so as to cause a handle defining projection to be formed in the preform.

20. A method of making a plastic container having an integral handle, comprising steps of:
(a) providing a preform that has a lateral projection that substantially corresponds to the desired shape and size of a handle;
(b) positioning the preform within a container mold assembly; and
(c) forming a completed container with an integral handle by molding the preform to the desired final shape that is defined by the container mold assembly.

21. A method of making a plastic container according to claim 20, wherein said step of positioning the preform within the container mold assembly is performed so as to pinch an area of said lateral projection together so as to define a sealed portion in which plastic material is sealed together.

22. A method of making a plastic container according to claim 21, wherein said step of positioning the preform within the container mold assembly is further performed so that said sealed portion will be formed as a slug that is sealed about its edges and is connected to the completed container by a frangible web, and further comprising a step of removing the slug from the completed container after the completed container is formed.

23. A mold assembly for making a plastic container having an integral handle, comprising:
an internal surface that a shape and size so as to correspond to a desired final shape of a container; and
sealing structure for pinching a lateral projection that is defined on a preform together so as to define a sealed portion in which plastic material is sealed together.

24. A mold assembly according to claim 23, wherein said sealing structure is constructed and arranged so that the sealed portion will be formed as a slug that is sealed about its edges and is connected to the completed container by a frangible web.
